(19) United States
(12) Patent Application Publication
(10) Pub. No.: US 2007/0258773 A1
(43) Pub. Date: Nov. 8, 2007

(54) Method and system for repairing subterranean structures

(76) Inventor: Roger Michael Bennett, Magnolia, TX (US)

Correspondence Address: Raj Kumar Krishnan, 7408 Summitview Drive, Irving, TX, 75063, US

(21) Appl. No.: 11/430,238

(22) Filed: May 8, 2006

(51) Int. Cl. F16L 55/18

(52) U.S. Cl. 405/184.1

(57) ABSTRACT

A system and method for repairing cracks and leaks in subterranean structures is disclosed. The system and method is particularly well suited for repairing damaged underground pipes from above ground. The system and method makes it possible to locate damaged areas of subterranean structures and inject an expandable polymer into those damaged areas without the need for extensive excavation. The system and method are also used to fill voids surrounding the damaged structure with the polymer. The need for excavation is minimized, creating a much safer project because men won't have to enter an open excavation and be exposed to cave-in hazards. Also, the risk of damage to neighboring utilities is greatly reduced. Furthermore, the system and method eliminates the cost of damaging adjacent trees, landscaping, and structures.

### FIELD OF THE INVENTION

The novel apparatus and method disclosed relates to the repair of subterranean structures such as pipes, manholes, basements, electrical junction boxes, and telecommunication conduits. In particular, the present invention relates to a noninvasive system and method for the location and repair of leaks in pipes that are located underground.

### BACKGROUND OF THE INVENTION

Damage to underground structures is an ongoing problem for residential and commercial property owners and municipalities. Cracks in underground pipes are particularly problematic for a number of reasons. In sewer lines, dirt and sand enter the pipe through the cracks and must be removed by water treatment plants. Additionally, rain water seeps into the pipe through the cracks, causing contamination. These problems may cause water treatment facilities to not meet applicable government standards. Furthermore, when dirt and sand seeps through the cracks, voids begin to form around the pipes, which can cause settling and shifting that can lead to further damage to the pipes.

Relining is a common method for repairing pipes. Rather than replacing entire sections of pipe, a lining can be applied to the pipe to create a seal at the cracks so that water, dirt, and sand will not enter through the cracks. There are many approaches for applying linings to the interior of pipes. However, this method can only be used to repair main lines and trunk lines. It is not effective for repairing joints between them, nor is it effective for repairing lateral pipes. Currently, the most common method for reparing damaged joints and lateral pipes is to excavate to the damage area. Excavation is very expensive and can cause damage to other intervening structures.

One method known in the prior art is to apply a long extension of tubing having an outer diameter that is substantially the same as the inner diameter of the damaged pipe. The lining is inserted in the damaged pipe from above ground through an access port. This method is not adequate because some underground pipes are located and configured in a manner that makes application of such a lining impossible. This method can also be very expensive and time consuming. Furthermore, the flow of water to the section being repaired must be cut off or bypassed for a substantial amount of time during application.

Several polymers have been developed that can be applied by injection into leaks and cracks and allowed to harden, creating a seal. Various methods have been developed for applying these polymers to leaks and cracks in subterranean structures. One such method, using a device called a “pig,” is disclosed in U.S Pat. Nos. 4,643,855 and 4,627,472. The pig is moved within the damaged pipe to the location of the leak and the sealant is then injected through the pig and applied to the leak. U.S. Pat. No. 6,416,692 discloses a method for applying a polymer sealant by inserting an internal lining tube into the problem area. The linings tube applies internal pressure to the damaged area while injecting the polymer. These prior methods and apparatuses fail to provide a means for locating the damaged area from above ground. They also apply pressure on the interior of the pipe. Because damaged areas in subterranean structures are frequently surrounded by voids, this pressure may result in further damage to the pipes.

Recently several two-part polymerization systems have been developed that consist of a catalyst and a polymerizable monomer that combine to form a polymer which hardens. The polymers formed by these systems are hydrophilic and create an excellent seal that will block the flow of water, sand, and dirt. U.S. Pat. No. 4,026,976 discloses a methodology for sealing a leak using a two-part polymerization system that consists of a catalytically polymerizable organic monomer and a poymerization catalyst. The catalyst is first applied to the site of the leak and thereafter the monomer is administered so that a polymer is then formed. The resulting polymer provides a solid seal to the site of the leak.

While these polymers are very effective for repairing damaged structures to prevent the flow of water, it still remains a problem to locate the damaged area. Furthermore, none of the prior systems and methods provides an adequate means for applying the polymer to the subterranean structures without extensive excavation. Therefore, none of the previous systems or methods has adequately addressed the problem of locating cracks and leaks and efficiently and effectively accessing the damaged area for administering the sealant.

### SUMMARY OF THE INVENTION

The problem of locating and repairing cracks and leaks in subterranean structures is addressed by the novel system and method disclosed. One such structure that may be repaired is a pipe such as a gravity flow sewer line. Leaks and cracks in the sewer line may be first located using a remote controlled camera device. Once the damaged portion has been located, a locator device that senses a signal from a transmitter located on the camera in the line below can be used aboveground to generally determine the location on the earth's surface above the camera.

The system and method disclosed herein comprises a device for administering water under high pressure that is connected to a conduit such as a pipe. The conduit is directed towards the location on the earth's surface above the camera. The water flowing through the conduit must be at such a pressure that it can displace soil on impact. Pressure is applied to the conduit so that the outlet of the pipe penetrates the soil and moves downward. This conduit, in addition to providing adequate water pressure to displace the soil in order to penetrate the ground, also provides a cushion of water on its leading edge which prevents the rigidity of the conduit to do further damage to the pipe or structure. When the outlet of the conduit reaches the outside of the damaged pipe, the water ejected by the conduit will begin to flow through the leaking portion of the pipe. This water flow may be observed by the camera device and therefore the operator can determine when the pipe has reached the leaking area. It is recommended to insert jet hose may also be inserted into the sewer line in the vicinity of the damaged area so as to evacuate excess material that may enter the line through damaged area.

The system and method also includes an injection mechanism for injecting expandable polyurethane polymer. The water supply from the water pressure device is stopped. The injection mechanism transfers the ingredients for a polymer into the conduit. The ingredients for the polymer are then transported to the outlet at the exterior of the damaged area. The polymer formed by the mixture of these ingredients will fill any voids that have formed on the exterior of the sewer line and will fill the cracks and leaks in the line. Polymer entering into the pipe can be observed using the camera device and can be jetted away by the jetting hose so that it will not obstruct the interior flow of the sewer line. As it hardens, the polymer forms a seal in the leaks and occupies the exterior voids so that the sewer line will be supported in place.

Other structures that may be repaired are underground manholes, box culverts and other underground concrete structures that can be safely accessed by men. For these repairs, the interior of the manhole structure is first cleaned and inspected to determine the location of cracks and leaks in the walls of the manhole. A hole is then drilled in the wall large enough for an injector to be inserted. The polymer injection mechanism is attached to an injector pipe and the injector is inserted into the drilled hole. The polymer is then injected and the operator observes the inner wall. After the polymer fills the voids on the other side of the wall, it will begin to fill the cracks in the structure walls as well. If any excess forms it may be removed manually.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side sectional view of the disclosed method during the location phase.

FIG. 2 is a top perspective sectional view of the disclosed method and apparatus during the repair of a faulty tap connection.

FIG. 3 is a side sectional view of the disclosed method with a push camera inserted into the pipe.

FIG. 4 is a top perspective sectional view of the disclosed method and apparatus during the repair of a faulty connection tap connection and leak, using an inflatable bladder.

FIG. 5 is a top sectional view of the disclosed method and apparatus during the repair of a faulty connection tap connection and leak, using an inflatable bladder.

FIG. 6 is a sectional view of the disclosed method and apparatus during the injection of expanding polymer material.

### DESCRIPTION OF THE PREFERRED EMBODIMENT

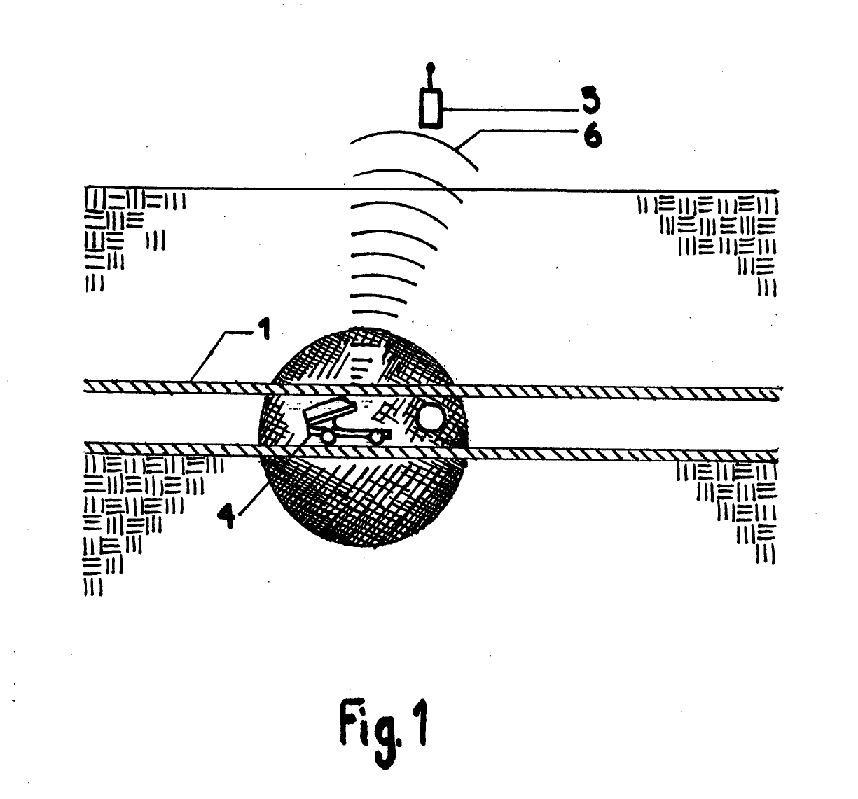

Referring to FIG. 1 of the drawings which form a part of the disclosure herein, a typical trunk line 1 of a sewer is shown. Intersecting with the trunk line 1 is a lateral line 2. The trunk line 1 and lateral line 2 are located underground and are connected by a joint 3. The disclosed system and method are suitable for repairing most subterranean structures. For illustrative purposes only, the description of the preferred embodiment contained herein will describe the use of the disclosed method and system for repairing damage in lateral lines such as the one shown in FIG. 1 and their associated joints.

Shown in FIG. 1 is a remote controlled motorized camera 4 with a transmitter or transponder that may be remotely controlled from aboveground. Many such cameras are known in the prior art and may be used, but one typical device is the Cues Pipe Ranger System, equipped with an OZ II camera. The camera 4 may also be equipped with an electronic locating device such as the Digitrak DDTS transmitter. The camera 4 may be inserted into the trunk line 1 and remotely operated, while the operator views the images it transmits. The operator will direct the camera 4 to proceed forward until the operator can see the damaged portion of the pipe in the images. While using a camera to locate leaks is not new, the system and method disclosed herein that enables the identification aboveground of the location of the camera and the repair of the leak from the outside of the pipes without excavation are not yet known.

In FIG. 1, the damaged portion that must be repaired is the joint between the trunk line 1 and the lateral. The camera 4 has been moved into the area and is transmitting images of the damaged joint. The location of the camera 4 is then detected from aboveground using an electronic sensing device 5, which detects a signal 6 emitted by the transmitter. Many electronic sensing devices are known and may be used. One such device is the Digitrak Mark III. The electronic sensing device 5 is moved in the general area that the camera 4 is located until it detects the signal emitted by the transmitter, indicating that the camera 4 is directly below it. The camera 4 being equipped with an electronic locator will register a signal in the electronic sensing device 5, making it easy to accurately identify its location.

While the method described above for identifying the location of the camera 4 has been identified as the preferred method, one of ordinary skill in the art would recognize that there are several other methods commonly known that might be used. By way of example, the camera 4 may be equipped with an odometer. The camera 4 transmits the reading on the odometer to the operator, allowing him to determine the distance that the camera 4 has traveled. The operator typically will know the starting point of the camera's path and the line on which the pipe is laid. The operator can, therefore, estimate the location on the earth's surface above the camera 4 by measuring the distance indicated on the odometer from the starting point of the camera 4 to the point aboveground on the same line as the pipe.

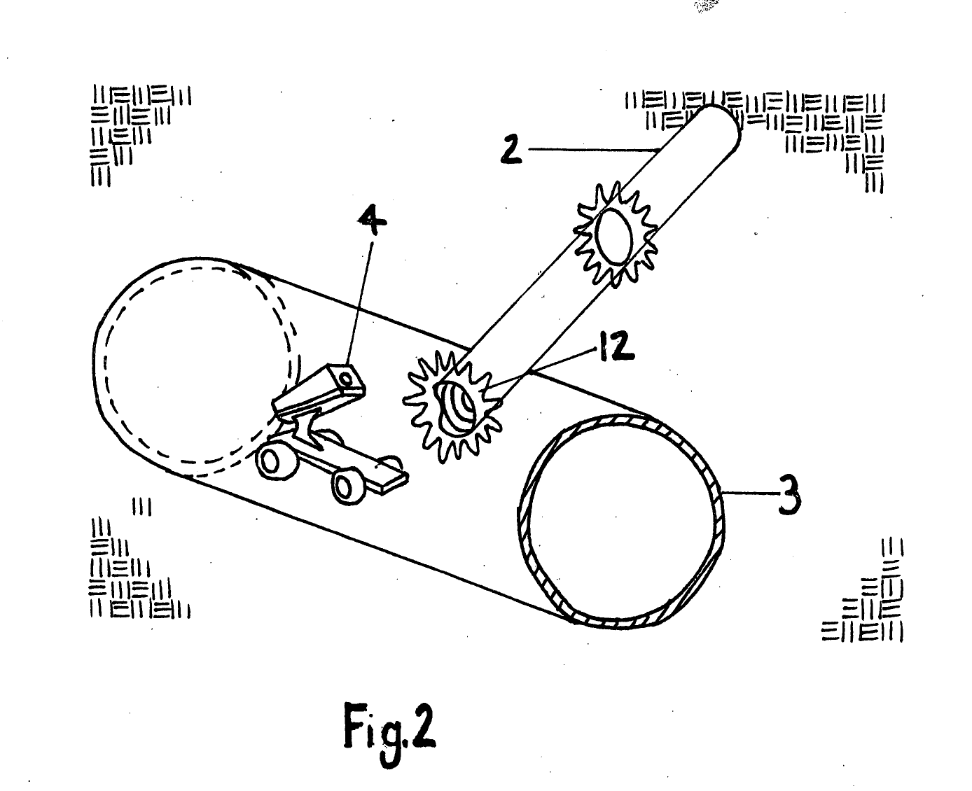

FIG. 2 illustrates the camera 4 located inside the trunk 1 and a lateral line 2 that is comprises cracks in at the joint to the trunk line 1 and at its midsection 12.

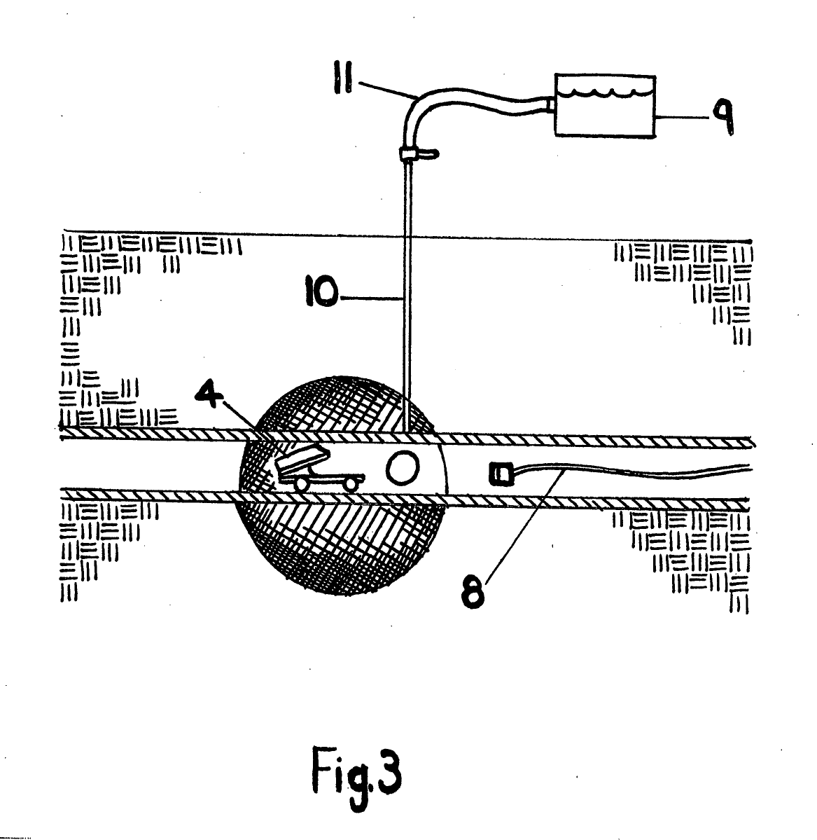

Now turning to FIG. 3, a conduit 10 is shown, which is connected to a high-pressure water supply. An example of an appropriate high-pressure water supply is the Simer jetting pump. The conduit 10 may be comprised of several materials and shapes. A preferred conduit is ⅜ inch copper tubing. The copper tubing is detachably connected to said high-pressure water supply by a hose. The conduit 10 is pointed towards the earth's surface at the location where the camera was detected by the electronic sensing device. The high-pressure water supply is then activated so that water is directed from the outlet end of the conduit 10 towards the earth's surface. By applying downward pressure to the conduit 10, the conduit will penetrate the earth's surface and proceed downward. When the conduit 10 reaches the location of the damaged joint 12, water from the conduit 10 will begin to enter through the cracks 13. The operator will see the water leaking through the cracks 13 via said images transmitted by the camera 4 and therefore will recognize that the conduit 10 has reached the area of the damaged joint 12. In order better monitor the damaged pipe during repair, a push camera may be inserted 8. An example of a push camera that may be used is the Cues 2020.

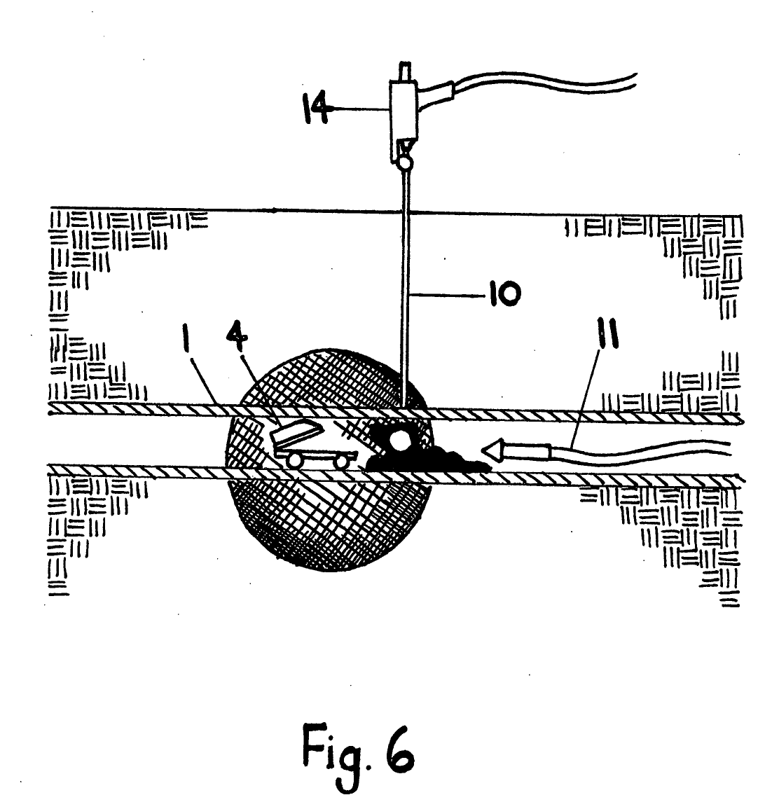

When the conduit has been inserted in the area exterior to the damaged joint 3, the high-pressure water source is disconnected from the conduit 10 and an injector 14 is connected to the conduit 10 as shown in FIG. 6. The injector 14 is attached to a supply of materials that, when combined, produce a hydro-insensitive polyurethane polymer. The materials are drawn separately to the injector 14 and transported together into the conduit 10. The materials react to form a polymer and the resulting polymer is ejected from the conduit 10 into the area of the damaged joint 12. The polymer will fill any voids on the exterior of the pipe and will fill the cracks 13 in the pipe to form a water tight seal. Some of the polymer will enter the trunk line 1 and therefore must be removed so that it will not harden and create an obstruction. The jet hose 7 is inserted into the area of the damaged joint in order to provide a stream of water that will remove the excess polymer out of the trunk line 1. The water sprayed by the jet hose 7 carries the polymer out of the trunk line 1 to the nearest outlet downstream. After the polymer hardens, the cracks in the damaged joint 13 will not allow any exterior water to flow into the trunk line 1. Additionally, the hazardous voids 16 outside the pipe are filled preventing further damage to the pipes.

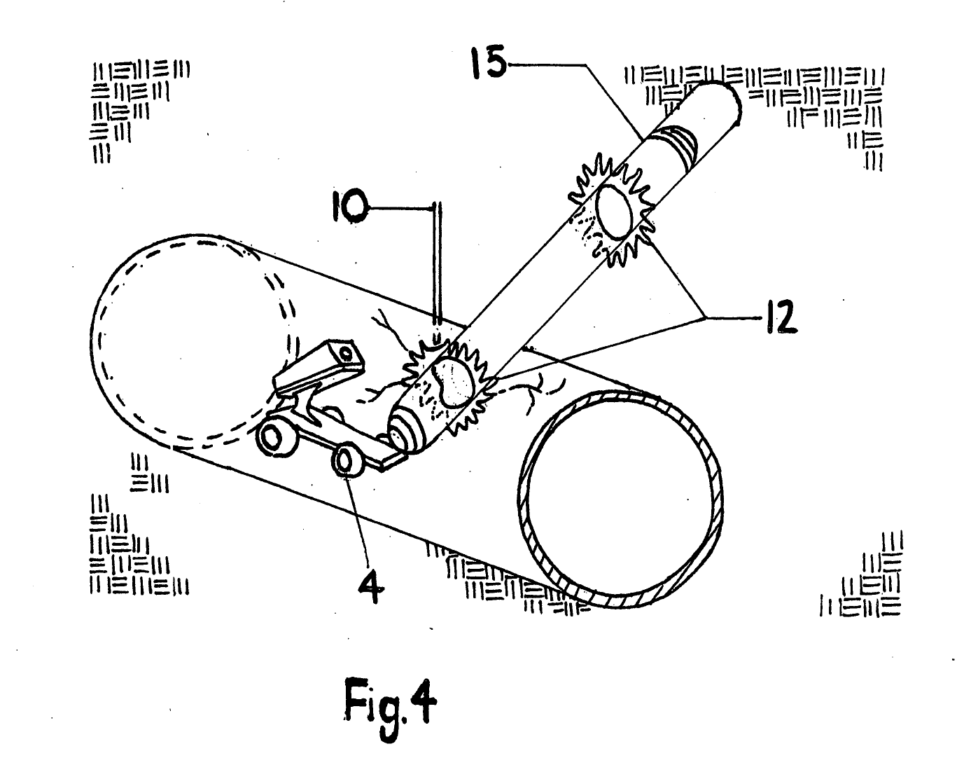

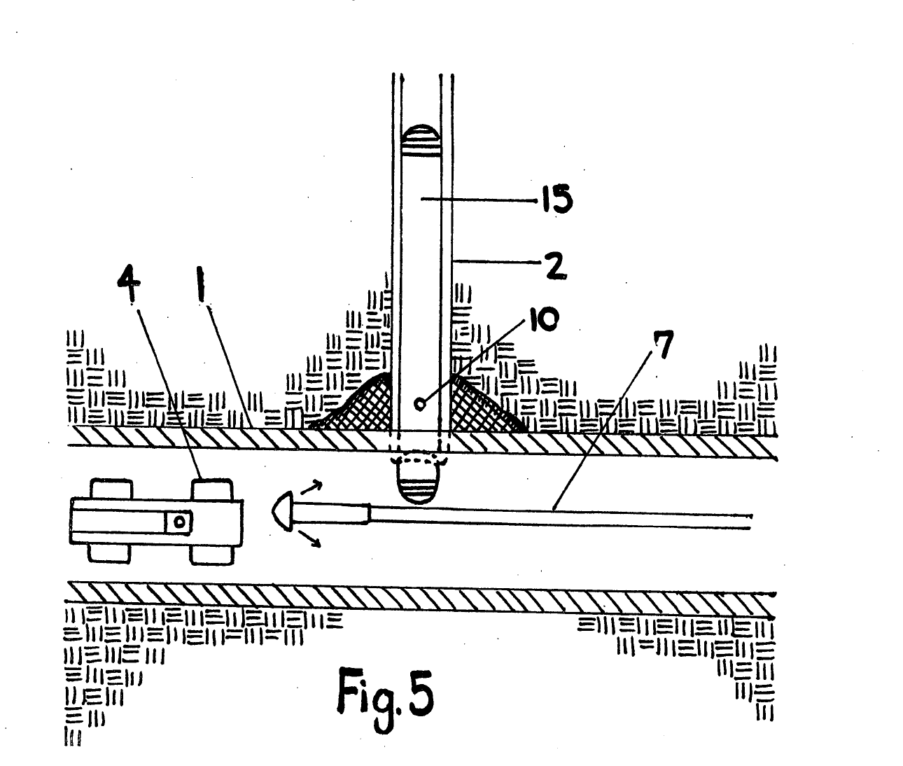

Now turning to FIGS. 4 and 5, in some cases, the damaged joints, pipes and trunk lines may be so damaged that the pressure of water and polymer injected by the conduit may create too much pressure on the exterior. This may cause further damage to the pipe by causing it to collapse. In those cases, it may be necessary to insert a bladder 15 into the line. The bladder 15 may be inflated with air so that it snugly fits inside the lateral line 2 and provides outward pressure on the interior surface of the damaged joint 12 and the damaged lateral line 2. Thus, when water or polymer is injected by the conduit 10, the pressure created on the exterior will not cause the pipe to collapse.

As shown in FIGS. 5 and 6, once the damaged joint has been located, a jet hose 7 may be inserted into the damaged lateral line along with a device known as a push camera 8. An example of a push camera that may be used is the Cues 2020. The jet hose 7 is connected to a high-pressure water supply.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

What is claimed is:

1. A method for repairing damaged subterranean structures comprising:
locating the damaged portion of a subterranean structure using a self-propelled camera, said self-propelled camera comprising a device capable of transmitting a signal;
using said signal to identify the location on the earth's surface above said damaged portion;
directing the outlet of a conduit into the location on the earth's surface above said damaged portion, said conduit connected to a high-pressure water supply;
emitting water from said high-pressure water supply through said outlet of said conduit and applying pressure to said conduit so as to penetrate into the earth's surface until said water may be seen entering said damaged subterranean structure by said remote controlled camera;
injecting a supply of materials capable of combining to form a polymer into said conduit so that they are injected together into said damaged portion of said subterranean structure.

2. The method of claim 1 wherein said subterranean structure comprises a pipe.

3. The method of claim 2 wherein said self-propelled camera further comprises an odometer for measuring the distance traveled by said camera.

4. The method of claim 3 wherein said signal communicates said distance.

5. The method of claim 4 wherein using said signal to identify the location on the earth's surface above said damaged portion comprises:
measuring said distance communicated by said signal from the starting point of the camera to the point aboveground on the same line as the pipe.

6. The method of claim 1 further comprising:
inserting a jet hose in said damaged subterranean structure in the location of said damaged portion, said jet hose being connected to a high-pressure water supply.

7. The method of claim 6 further comprising:
using said jet hose connected to a high pressure water supply to wash away any of said polymer that enters the interior of said subterranean structure.

8. The method of claim 1 further comprising:
using a sensing device capable of detecting said signal to detect the location on the earth's surface above said camera.

9. The method of claim 1 further comprising:
inserting a bladder into the interior of said damaged portion of said subterranean structure, prior to injecting said supply of materials that combine to form a polymer.

10. The method of claim 1 wherein said self-propelled camera may be controlled remotely.

11. A system for repairing damaged portions of subterranean structures comprising:
a self-propelled camera inserted into a subterranean structure, said self-propelled camera being equipped with a transmitter and said self-propelled camera having been directed to the location of a damaged portion of the subterranean structure;
a conduit directed at the location of the earth's surface above said self-propelled camera, said conduit capable of ejecting water at a high pressure and also capable of ejecting materials, said materials comprising the ingredients for a polymer;
wherein said conduit emits water so as to penetrate the ground until said water is detected using said self-propelled camera and wherein said conduit then emits said materials.

12. The system of claim 11 further comprising:
a jet hose inserted into the interior of said subterranean structure at the location of said damaged portion of said subterranean structure.

13. The system of claim 11 further comprising:
a bladder which has been inserted into the interior of said subterranean structure at the location of said damaged portion of said subterranean structure.

14. The system of claim 11 further comprising:
an aboveground electronic sensing device capable of sensing a signal emitted by said transmitter.

15. The system of claim 14 wherein said location above said camera on the earth's surface was determined using said aboveground electronic sensing device.

16. The system of claim 11 wherein said subterranean structure comprises a pipe.

17. The system of claim 16 wherein said self-propelled camera further comprises an odometer for measuring the distance traveled by said camera.

18. The system of claim 17 wherein said signal communicates said distance measured by said odometer.

19. The method of claim 18 wherein said conduit directed at the location of the earth's surface above said self-propelled camera was positioned by measuring said distance communicated by said signal from the starting point of the camera to the point aboveground on the same line as the pipe.

20. The system of claim 11 wherein said self-propelled camera may be controlled remotely.
